(19) United States
(12) Patent Application Publication
(10) Pub. No.: US 2022/0239748 A1
(43) Pub. Date: Jul. 28, 2022

(54) CONTROL METHOD AND DEVICE

(71) Applicant: Lenovo (Beijing) Limited, Beijing (CN)

(72) Inventors: Juan WU, Beijing (CN); Xiaoxi LIU, Beijing (CN); Zenghui JIAO, Beijing (CN)

(21) Appl. No.: 17/551,855

(22) Filed: Dec. 15, 2021

(30) Foreign Application Priority Data
Jan. 27, 2021 (CN) 202110113143.3

(51) Int. Cl. H04L 67/142; H04L 67/141; H04L 43/0852

(52) U.S. Cl. CPC H04L 67/142; H04L 43/0852; H04L 67/141

(57) ABSTRACT

A control method includes when receiving host information sent by a management node in an edge node network, determining a current edge node as a host edge node, establishing a communication connection with the offline edge node according to the node information in the host information, obtaining a current node state of the offline edge node through the communication connection, and transmitting the current node state of the offline edge node to the management node. The host information includes at least node information of a hosted offline edge node.

### CROSS-REFERENCE TO RELATED APPLICATION

This application claims priority to Chinese Patent Application No. 202110113143.3, filed on Jan. 27, 2021, the entire content of which is incorporated herein by reference.

### TECHNICAL FIELD

The present disclosure generally relates to the computer technology field and, more particularly, to a control method and a device.

### BACKGROUND

In an edge computing network, many edge nodes are deployed in unattended remote areas. A network connection between the edge nodes and a cloud management node can be very unstable. When the edge node is disconnected from the cloud management node, the edge node is offline. At this time, the edge node will automatically start a local container management agent Edged when the edge node is working normally to restart the local service using cached metadata. In addition, the edge node may not work properly due to a malfunction.

However, the management node cannot determine the state of the node after detecting that the node is disconnected and thus cannot determine whether the node can provide services normally.

### SUMMARY

Embodiments of the present disclosure provide a control method. The method includes when receiving host information sent by a management node in an edge node network, determining a current edge node as a host edge node, establishing a communication connection with the offline edge node according to the node information in the host information, obtaining a current node state of the offline edge node through the communication connection, and transmitting the current node state of the offline edge node to the management node. The host information includes at least node information of a hosted offline edge node.

Embodiments of the present disclosure provide a control method. The method includes detecting whether an offline edge node exists in an edge node network, when detecting at least one offline edge node, determining a host edge node for the offline edge node, sending host information to the host edge node, so that the host edge node establishes a communication connection with the offline edge node according to node information of the hosted offline edge node included in the host information and obtains a current node state of the offline edge node through the communication connection, and obtaining the current node state of the offline edge node transmitted by the host edge node.

Embodiments of the present disclosure provide a control device, including an information reception unit, a host determination unit, a connection establishment unit, a state acquisition unit, and a transmission unit. The information reception unit is configured to receive host information sent by a management node in an edge node network. The host determination unit is configured to, when receiving the host information sent by the management node in the edge node network, determine a current edge node as a host edge node. The host information includes at least node information of a hosted offline edge node. The connection establishment unit is configured to establish a communication connection with the offline edge node according to the node information in the host information. The state acquisition unit is configured to obtain a current node state of the offline edge node through the communication connection. The transmission unit is configured to transmit the current node state of the offline edge node to the management node.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic flowchart of a control method according to some embodiments of the present disclosure.

FIG. 2 illustrates a schematic architectural diagram of an edge node network according to some embodiments of the present disclosure.

FIG. 3 illustrates a schematic flowchart of a control method according to some other embodiments of the present disclosure.

FIGS. 4 and 5 illustrate schematic flowcharts showing a portion of the control method according to some other embodiments of the present disclosure.

FIG. 6 illustrates another schematic flowchart of the control method according to some other embodiments of the present disclosure.

FIG. 7 illustrates a schematic structural diagram of a control device according to some other embodiments of the present disclosure.

FIG. 8 illustrates a schematic structural diagram of a control device according to some other embodiments of the present disclosure.

FIG. 9 illustrates a schematic structural diagram of an electronic apparatus according to some other embodiments of the present disclosure.

FIG. 10 illustrates a schematic structural diagram of an electronic apparatus according to some other embodiments of the present disclosure.

FIG. 11 illustrates a schematic diagram showing an interaction among a management node, a host edge node, and an offline edge node according to some embodiments of the present disclosure.

FIG. 12 illustrates a schematic diagram of a practical application in detail according to some embodiments of the present disclosure.

FIGS. 13 and 14 illustrate schematic diagrams of determining a host edge node according to some embodiments of the present disclosure.

### DETAILED DESCRIPTION OF THE EMBODIMENTS

The technical solutions of embodiments of the present disclosure are described in detail below in conjunction with the accompanying drawings in embodiments of the present disclosure. Apparently, described embodiments are only some embodiments of the present disclosure rather than all embodiments. Based on embodiments of the present disclosure, all other embodiments obtained by those of ordinary skill in the art without creative work shall be within the scope of the present disclosure.

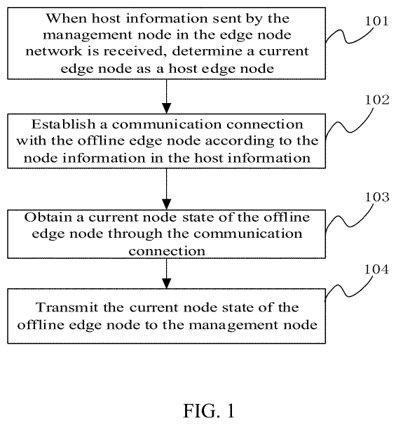

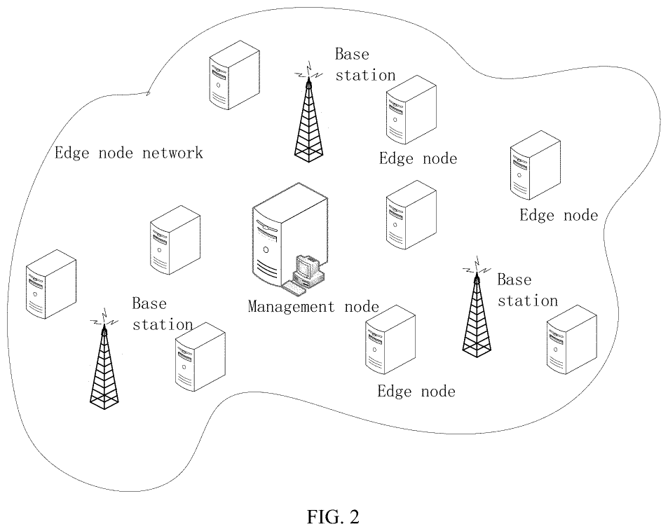

FIG. 1 illustrates a schematic flowchart of a control method according to some embodiments of the present disclosure. The control method is applicable to any edge node in an edge node network. An edge node may be different from a management node in the edge node network. The management node may also be referred to as a cloud management node. As shown in FIG. 2, the edge node network includes one management node and a plurality of edge nodes. One or more edge nodes correspond to a base station. The edge node network also includes a backup node of the management node. The edge nodes in the edge node network may include electronic apparatuses capable of performing data processing, such as an edge-side apparatus of an edge controller, an edge gateway, and an edge server. These edge-side apparatuses have common capabilities of edge-side real-time data analysis, local data storage, and real-time network connection. The plurality of edge nodes may form the edge node network. The management node may be arranged in the edge node network and configured to unified-manage the plurality of edge nodes in the edge node network, for example, managing the edge node states. The technical solution of embodiments of the present disclosure is mainly used to obtain a node state of an offline edge node in the edge node network.

In some embodiments, the method includes the following steps.

At 101, when host information sent by the management node in the edge node network is received, a current edge node is determined as a host edge node.

The host information may include at least node information of the offline edge node that is hosted to indicate that the edge node corresponding to the node information is in an offline state, that is, a state of being disconnected from the management node.

In the method of embodiments of the present disclosure, the current edge node may not receive the host information of the management node. Only when the management node detects one or more offline edge nodes in the edge node network and the current edge node is determined as a host edge node corresponding to the offline edge nodes by the management node, the host information may be sent to the current edge node. Therefore, only the current edge node that receives the host information sent by the management node may be determined as the host edge node corresponding to the offline edge nodes.

Based on this, in some embodiments, when the current edge node receives the host information sent by the management node, the current edge node may be determined to be the host edge node corresponding to the offline edge nodes corresponding to the node information in the host information based on the host information.

At 102, a communication connection with the offline edge node is established according to the node information in the host information.

In some embodiments, the node information in the host information may be analyzed to determine the offline edge node hosted by the host edge node. Then, the host edge node may establish the communication connection between the host edge node and the offline edge node.

A communication type of the communication connection here may be different from a communication type of communication between the edge node and the management node in the edge node network.

At 103, a current node state of the offline edge node is obtained through the communication connection.

In some embodiments, information content sent by the offline edge node, such as current state information, etc., may be received through the communication connection between the host edge node and the offline edge node. Then, according to whether the host edge node receives the current state information sent by the offline edge node to the host edge node through the communication connection, the current node state of the offline edge node may be obtained.

At 104, the current node state of the offline edge node is transmitted to the management node.

In some embodiments, the host edge node may transmit the current node state of the offline edge node to the management node through the communication connection between the host edge node and the management node. As such, the management node may obtain the current node state of the offline edge node.

According to the above solution, the control method of embodiments of the present disclosure may include detecting whether the offline edge node exists in the edge node network at the management node of the edge node network. When at least one offline edge node is detected, the management node may determine the host edge node for the offline edge node and send the host information to the host edge node. Thus, the host edge node may obtain the current node state of the offline node after establishing the communication connection with the offline edge node according to the node information of the offline edge node that is hosted included in the host information. As such, the management node may obtain the current node state of the offline edge node transmitted by the management node. Thus, in embodiments of the present disclosure, even if the offline edge node, that is the disconnected node, exists, the management node may obtain the node state of the offline node. Therefore, the management node may determine whether the node can provide service normally.

In some embodiments, each edge node in the edge node network includes a communication module and a communication profile. Therefore, when being determined as the offline edge node by the management node, each edge node may be used as a host edge node to establish the communication connection with the offline edge node according to the communication profile through the communication module. In some embodiments, in step 102, when the host edge node establishes the communication connection between the host edge node and the offline edge node according to the node information in the host information, the method includes the following step.

A first communication identifier in the host edge node may be used to establish the communication connection with the offline edge node.

In some embodiments, the communication profile in the host edge node may include the first communication identifier. Thus, the host edge node may establish the communication connection between the host edge node and the offline edge node according to the first communication identifier in the communication profile through the communication module and another configuration content. As such, the host edge node may wait to receive information content sent by the offline edge node based on the communication connection.

For example, the communication module in the host edge node may include a subscriber identity module (SIM) card control module. The communication profile in the host edge node may include a communication account, such as a SIM card number previously applied to a communication operator and the another configuration content required for establishing the communication connection. Therefore, the host edge node may receive the host information sent by the management node and determine the offline edge node hosted by the host edge node first. Then, the host edge node may activate the communication profile in the host edge node through the SIM card control module to cause the SIM card number to be in an activated state. Thus, the host edge node may establish the communication connection with the offline edge node through the activated SIM card number. As such, the host edge node may wait to receive the information content sent by the offline edge node through the communication connection.

In some embodiments, in step 103, when obtaining the current node state of the offline edge node through the communication connection, the method includes the following two situations.

In a first situation, when the host edge node receives the current state information sent by the offline edge node to the host edge node through the communication connection, the host edge node may obtain the current node state of the offline edge node according to the current state information. The current node state may indicate that the offline edge node is in an autonomous state or a service unavailable state.

Any one of the edge nodes in the edge node network detects its disconnection from the management node. That is, when the edge node is determined to be an offline edge node, the offline edge node may use a built-in communication module, e.g., a SIM card control module, to apply for a second communication identifier, e.g., a dynamic SIM card number, from a communication base station of the communication operator. Thus, the host edge node may broadcast and send the current state information of the offline edge node based on the second communication identifier. Therefore, the communication connection may be established between the edge node and the offline edge node. Based on this, the host edge node may receive the current state information sent by the offline edge node through the communication connection.

In addition, when the offline edge node sends the current state information to the host node through the communication connection, the offline edge node may be indicated to be not unable to establish a communication connection and send information due to a failure. At this time, the current state information sent by the offline edge node through the communication connection may indicate that the offline edge node can send information out but is in the service unavailable state or the autonomous state. Based on this, the host edge node may generate the current node state of the offline edge node according to the received current state information of the offline edge node. In some embodiments, the received current state information may be directly used as the current node state, or the current node state may be generated according to the current state of the offline edge node indicated by the current state information.

In a second situation, when the host edge node cannot receive the current state information sent by the offline edge node to the host edge node through the communication connection, the host edge node may obtain the current node state of the offline edge node. The current node, at this time, the current node state may indicate that the offline edge node is in a failure state.

Any one of the edge nodes in the edge node network detects its disconnection from the management node. That is, when the edge node is determined to be an offline edge node, the offline edge node may use the built-in communication module, e.g., a SIM card control module, to apply for a second communication identifier, e.g., a dynamic SIM card number, and download the corresponding communication profile from a communication base station of the communication operator. Thus, the host edge node may broadcast and send the current state information of the offline edge node based on the second communication identifier. However, when the offline edge node is in a failure state, the offline edge node may not be able to apply for the SIM card number from the communication base station of the communication operator, or the offline edge node may not be able to send the information according to the applied SIM card number. Thus, although the host edge node may establish the communication connection with the offline edge node through the first communication identifier, but cannot receive the current state information sent by the offline edge node. Based on this, when the host edge node cannot receive the current state information of the offline edge node through the communication connection, the host edge node may directly obtain the current node state of the offline edge node based on the situation that the information cannot be received. For example, when the host edge node cannot receive the information sent by the offline edge node, the host edge node may directly generate the current node state that indicates that the offline edge node is in the failure state.

Further, when the host edge node receives the current state information sent by the offline edge node to the host edge node through the communication connection, the host edge node may also determine the state update frequency with the offline edge node through the communication connection. Thus, the offline edge node may update the current state information of the offline edge state according to the state update frequency and send the current state information to the host edge node. As such, the host edge node may continuously update the current node state of the offline edge node according to the updated current state information until the current state information indicates that the offline edge node and the management node are in a connected state, and the offline edge node may no longer send current state information to the host edge node.

Based on this, the offline edge node and the host edge node may close the established communication connections simultaneously or sequentially. For example, the offline edge node may close the communication connection through the SIM card control module in the node and delete the downloaded and activated communication profile. Therefore, the applied SIM card number may be released. The host edge node may close the communication connection through the SIM card control module in the node and switch the activated SIM card number to the inactive state.

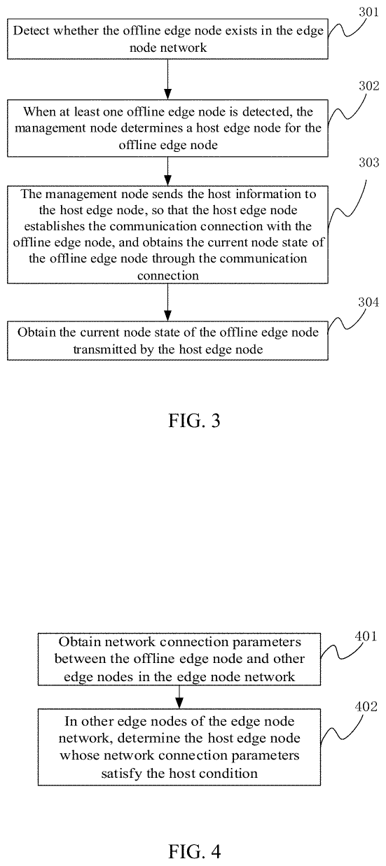

FIG. 3 illustrates a schematic flowchart of a control method according to some other embodiments of the present disclosure. The method may be suitable for the management node in the edge node network. The technical solution of embodiments of the present disclosure may be mainly used to obtain the node state of the offline edge node in the edge node network.

In some embodiments, the method includes the following steps.

At 301, whether the offline edge node exists in the edge node network is detected.

The management node may detect websocket connections with the edge nodes in the edge node network through the monitoring module. As such, whether the edge node that is disconnected from the management node (i.e., the offline edge node) exists may be detected.

At 302, when at least one offline edge node is detected, the management node determines a host edge node for the offline edge node.

The management node may select a suitable host edge node for the offline edge node according to the current node state of the edge nodes in the edge node network.

At 303, the management node sends the host information to the host edge node so that the host edge node establishes the communication connection with the offline edge node and obtains the current node state of the offline edge node through the communication connection.

The management node may send the host information to the host edge node through the communication connection with the host edge node, such as a websocket connection. The host information may include the node information of the offline edge node that is hosted. Therefore, after the host edge node receives host relationship information, the host edge node may establish the communication connection with the offline edge node according to the node information. The communication connection may be different from the connection between the offline edge node and an associated node when it is not lost. Based on this, the host edge node may obtain the current node state of the offline edge node through the communication connection. Then, the host edge node may send the current node state of the offline edge node to the management node through the communication connection with the management node.

For the method of the host edge node obtaining the current node state of the offline edge node through the communication connection, reference may be made to the corresponding content above, which is not described here in detail.

At 304, the current node state of the offline edge node transmitted by the host edge node is obtained.

The management node may receive the current node state of the offline edge node sent by the host edge node. Thus, the management node may obtain the current node state of the offline edge node transmitted by the host edge node.

The control method of some other embodiments of the present disclosure includes detecting whether the offline edge node exists in the edge node network in the management node of the edge node network. When at least one offline edge node is detected, the management node may determine the host edge node for the offline edge node and send the host information to the host edge node. Therefore, the host edge node can establish the communication connection with the offline edge node according to the node information of the offline edge node that is hosted included in the host information. Then, the host edge node may obtain the current node state of the offline edge node through the communication connection. As such, the management node may obtain the current node state of the offline edge node transmitted by the host edge node. Therefore, in embodiments of the present disclosure, even if the offline node, that is, a disconnected node, exists, the management node may also obtain the node state of the offline node and then determine whether the node can provide services normally.

In some embodiments, the management node may only be able to process relevant parameters of neighboring base stations in the edge node network or may be able to process the relevant parameters of the edge nodes in the edge node network and the relevant parameters of the neighboring base stations simultaneously. Based on these two situations, a different method may be used to determine the host edge node.

In some embodiments, the management node may simultaneously process the relevant parameters of the edge nodes in the edge node network, e.g., the network topology and performance index data between the nodes and the relevant parameters of the neighboring base stations. In step 302, when the management node determines the host edge node for the offline edge node, the method includes the following steps shown in FIG. 4.

At 401, network connection parameters between the offline edge node and other edge nodes in the edge node network are obtained.

The management node may collect the parameter information of all the edge nodes and nearby base stations in the edge node network through its built-in host node scheduling module. The parameter information may include location information of the edge node, a base station to which the edge node belongs, and a load of the base station. The parameter information may also include location information of neighboring base stations and a load such as a bandwidth utilization rate. Based on this, the management node may obtain network connection parameters between the offline edge node and other edge nodes in the edge node network based on the information. The network connection parameters may include network transmission delay parameters, that is, end-to-end delay parameters, and parameter information such as network routing and forwarding hops.

At 402, in other edge nodes of the edge node network, the host edge node whose network connection parameters satisfy the host condition is determined.

In embodiments of the present disclosure, the network connection parameters between the offline edge node and each of the other edge nodes in the edge node network may be analyzed. For example, the network connection parameters may be compared with the host conditions. Thus, the edge node whose network connection parameters satisfy the host conditions may be determined as the host edge node of the offline edge node from these other edge nodes.

In some embodiments, the host conditions may include the network transmission delay parameter between the host edge node and the offline edge node being the smallest among network transmission delay parameters between all the edge nodes in the edge node network and the offline edge node, and/or, the number of network routing forwarding hops between the host edge node and the offline edge node being the smallest among numbers of the network routing forwarding hops between all the edge nodes in the edge node network and the offline edge node.

In embodiments of the present disclosure, the edge node having the smallest network transmission delay with the offline edge node may be found in the edge node network and used as the host edge node of the offline edge node. In some other embodiments, the edge node having the smallest number of network routing forwarding hops may be found in the edge node network and used as the host edge node of the offline edge node. In some other embodiments, the edge node having the smallest network transmission delay with the offline edge node and the smallest number of network routing forwarding hops may be found in the edge node network and used as the host edge node of the offline edge node.

In embodiments of the present disclosure, one or more offline edge nodes may be included. When one offline edge node is included, the edge node having the smallest network transmission delay with the offline edge node may be found in the edge node network and used as the host edge node of the offline edge node. In some other embodiments, the edge node having the smallest number of network routing forwarding hops with the offline edge node may be found in the edge node network and used as the host edge node of the offline edge node. In some other embodiments, the edge node having the smallest network transmission delay with the offline edge node and the smallest number of network routing forwarding hops with the offline edge node may be found in the edge node network and used as the host edge node of the offline edge node. When more offline edge nodes are included, the edge node having the smallest average transmission delay with each of the offline edge nodes may be found in the edge node network and used as the host edge node. In some other embodiments, the edge node having the smallest average number of the network routing forwarding hops with each of the offline edge nodes may be found in the edge node network and used as the host edge node of the offline edge node. In some other embodiments, the edge node having the smallest average network transmission delay with each of the offline edge nodes and the smallest average number of network routing forwarding hops with each of the offline edge nodes may be found in the edge node network and used as the host edge node of the offline edge node.

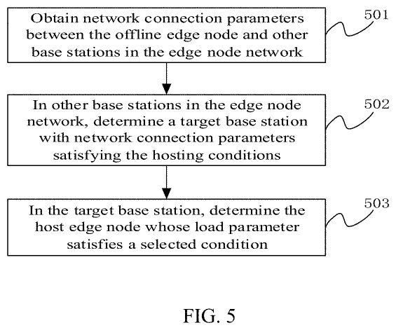

In some other embodiments, the management node can only process the relevant parameters of the neighboring base stations. In step 302, when the management node determines the host edge node for the offline edge node, the method includes the following steps, as shown in FIG. 5.

At 501, network connection parameters between the offline edge node and other base stations in the edge node network are obtained.

The other base stations may include base stations in the edge node network that are different from the base stations to which the offline edge nodes belong and are neighboring base stations to the base stations to which the offline edge nodes belong. In embodiments of the present disclosure, the parameter information of all the edge nodes and neighboring base stations may be collected through the built-in host node scheduling module. The parameter information may include edge node location information, a belonging base station, a load, etc., and may also include base station location information and load, e.g., information such as bandwidth utilization rate. Based on this, the management node may obtain the network connection parameters between the offline edge node and other base stations in the edge node network based on the information. The network connection parameter may include the available bandwidth of the base station and the distance between the management node and the offline edge node.

At 502, in other base stations in the edge node network, a target base station with network connection parameters satisfying the hosting conditions is determined.

In embodiments of the present disclosure, the network connection parameters between the offline edge node and each neighboring base station of the offline edge node in the edge node network may be analyzed. For example, the network connection parameters may be compared with the host conditions. Then, the target base station with the network connection parameter satisfying the host conditions may be determined from the other base stations.

In some embodiments, the host conditions may include that the target base station may include a base station with a bandwidth greater than or equal to a bandwidth threshold and the smallest distance from the offline edge node in the edge node network.

In embodiments of the present disclosure, in the edge node network and the neighboring base stations of the offline edge node, the base station with the smallest distance to the offline edge node and the available bandwidth greater than or equal to the bandwidth threshold may be found and used as a reference base station for searching for the host edge node of the offline edge node.

At 503, in the target base station, the host edge node whose load parameter satisfies a selected condition is determined.

The target base station may correspond to a plurality of edge nodes. The load parameter satisfying the selected condition may include that the host edge node is an edge node with the smallest load in the target base station.

In embodiments of the present disclosure, in the base stations neighboring to the offline edge node in the edge network node, the target base station with the smallest distance from the offline edge node and the available bandwidth greater than or equal to the bandwidth threshold may be found and used as the reference base station of the host edge node of the offline edge node. Then, an edge node with the smallest load, that is, the largest available resource, may be found in the target base station and used as the host edge node of the offline edge node.

In embodiments of the present disclosure, one or more offline edge nodes may be included. When one offline edge node is included, in some embodiments, the target base stations with the smallest distance from the offline edge node and the available bandwidth greater than or equal to the bandwidth threshold may be found in the edge node network and the base stations neighboring to the offline edge node. Then, the edge node with the smallest load may be found in a coverage area of the target base station and determined as the host edge base station of the offline edge node. When more offline edge nodes are included, in embodiments of the present disclosure, the target base stations with the smallest average distance from each of the offline edge nodes and the available bandwidth greater than or equal to the bandwidth threshold may be found in the edge node network and the base stations neighboring to the offline edge nodes. Then, the edge node with the smallest load may be found in the coverage area of the target base station and determined as the host edge base station of the offline edge nodes.

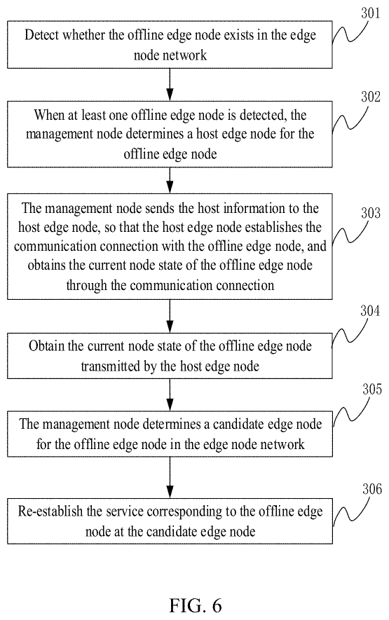

In some embodiments, when the current node state of the offline edge node indicates that the offline edge node is in a service unavailable state or a failure state, the method of embodiments of the present disclosure may further include the following steps, as shown in FIG. 6.

At 305, the management node determines a candidate edge node for the offline edge node in the edge node network.

The management node may find an edge node in the edge node network that can re-establish the service corresponding to the offline edge node according to information such as a service type corresponding to the offline edge node and the required load. The edge node may be used as a candidate edge node of the offline edge node.

At step 306, the service corresponding to the offline edge node is re-established at the candidate edge node.

In other words, the management node may re-establish the service run by the offline edge node on the candidate edge node to ensure to provide the service to the outside. Simultaneously, an operation and maintenance technician may be notified to repair the failure of the offline edge node.

In addition, when the current node state of the offline edge node indicates that the offline edge node is in the autonomous state, the management node may also update the state of the edge node in the database and wait for the recovery of the connection between the offline edge node and the management node.

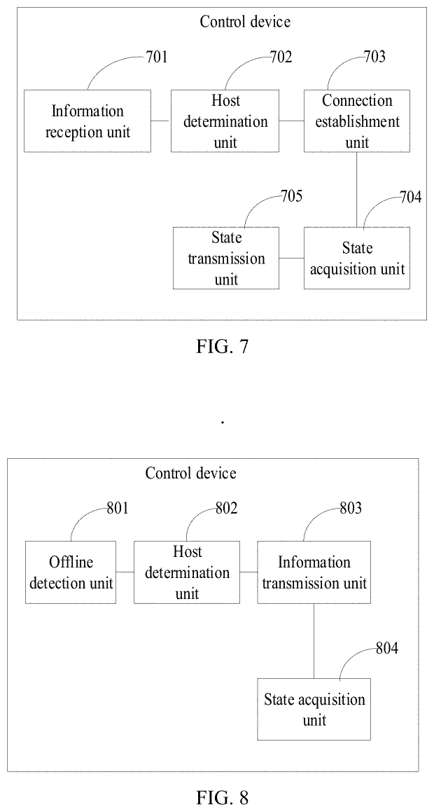

FIG. 7 illustrates a schematic structural diagram of a control device according to some other embodiments of the present disclosure. The device may be arranged at any edge node in the edge node network. The technical solution of embodiments of the present disclosure may be mainly used to obtain the node state of the offline edge node in the edge node network.

In some embodiments, the device includes an information reception unit 701, a host determination unit 702, a connection establishment unit 703, a state acquisition unit 704, and a state transmission unit 705. The information reception unit 701 may be configured to receive the host information sent by the management node in the edge node network. The host determination unit 702 may be configured to, when receiving the host information sent by the management node, determine the current edge node as the host edge node. The host information may include at least the node information of the offline edge node that is hosted. The connection establishment unit 703 may be configured to establish the communication connection with the offline edge node according to the node information in the host information. The state acquisition unit 704 may be configured to obtain the current node state of the offline edge node through the communication connection. The state transmission unit 705 may be configured to transmit the current node state of the offline edge node to the management node.

Embodiments of the present disclosure provide a control device. The device may detect whether the offline edge node exists in the edge node network at the management node of the edge node network. When at least one offline edge node is detected, the management node may determine the host edge node for the offline edge node and send the host information to the host edge node. Thus, the host edge node may obtain the current node state of the offline node after establishing the communication connection with the offline edge node according to the node information of the offline edge node that is hosted included in the host information. As such, the management node may obtain the current node state of the offline edge node transmitted by the management node. Thus, in embodiments of the present disclosure, even if the offline edge node, that is the disconnected node, exists, the management node may obtain the node state of the offline edge node. Therefore, the management node may determine whether the node can provide service normally.

In some embodiments, the connection establishment unit 703 may be configured to use the first communication identifier in the host edge node to establish the communication connection with the offline edge node.

In some embodiments, the state acquisition unit 704 may be configured to, when receiving the current state information sent by the offline edge node to the host edge node through the communication connection, obtain the current node state of the offline edge node according to the current state information. The current node state may indicate that the offline edge node is in the autonomous state or the service unavailable state. When the state acquisition unit 704 cannot receive the current state information sent by the offline edge node to the host edge node through the communication connection, the state acquisition unit 704 may be further configured to obtain the current node state of the offline edge node. The current node state may indicate that the offline edge node is in the failure state.

In some embodiments, when receiving the current state information sent by the offline edge node to the host edge node through the communication connection, the state acquisition unit 704 may be further configured to determine a state update frequency through the communication connection and the offline edge node. Thus, the offline edge node may update the current state information of the offline edge node according to the state update frequency and send the current state information to the host edge node until the current state information indicates that the offline edge node and the management node are in a connected state.

For the specific implementation of the unit in embodiments of the present disclosure, reference may be made to the corresponding content above, which is not be repeated in detail here.

FIG. 8 illustrates a schematic structural diagram of a control device according to some other embodiments of the present disclosure. The device may be configured as a management node in an edge node network. The technical solution of embodiments of the present disclosure is mainly used to obtain the node state of the offline edge node in the edge node network.

In some embodiments, the device includes an offline detection unit 801, a host determination unit 802, an information transmission unit 803, and a state acquisition unit 804. The offline detection unit 801 may be configured to detect whether the offline edge node exists in the edge node network. The host determination unit 802 may be configured to determine the host edge node for the offline edge node when the offline detection unit 802 detects at least one offline edge node. The information transmission unit 803 may be configured to send the host information to the host edge node so that the host edge node may establish the communication connection with the offline edge node according to the node information of the hosted offline edge node included in the host information, and obtain the current node state of the offline edge node through the communication connection. The state acquisition unit 804 may be configured to obtain the current node state of the offline edge node transmitted by the host edge node.

According to the above solution, the control device of embodiments of the present disclosure may detect whether the offline edge node exists in the edge node network at the management node of the edge node network. When at least one offline edge node is detected, the management node may determine the host edge node for the offline edge node and send the host information to the host edge node. Thus, the host edge node may obtain the current node state of the offline node after establishing the communication connection with the offline edge node according to the node information of the offline edge node that is hosted included in the host information. As such, the management node may obtain the current node state of the offline edge node transmitted by the management node. Thus, in embodiments of the present disclosure, even if the offline edge node, that is the disconnected node, exists, the management node may obtain the node state of the offline edge node. Therefore, the management node may determine whether the node can provide service normally.

In some embodiments, the host determination unit 802 may be configured to obtain network connection parameters between the offline edge node and other edge nodes in the edge node network and determine the host edge node with the network connection parameters satisfying the host conditions in other edge nodes of the edge node network.

The host conditions may include the network transmission delay parameter between the host edge node and the offline edge node being the smallest among network transmission delay parameters between all the edge nodes in the edge node network and the offline edge node, and/or, the number of network routing forwarding hops between the host edge node and the offline edge node being the smallest among numbers of the network routing forwarding hops between all the edge nodes in the edge node network and the offline edge node.

In some embodiments, the host determination unit 802 may be configured to obtain the network connection parameters between the offline edge node and other base stations in the edge node network. The other base stations may include the base stations in the edge node network that are different from the base stations to which the offline edge node belongs. In the other base stations in the edge node network, the host determination unit 802 may be configured to determine the target base station whose network connection parameters satisfy the host conditions and, in the target base station, determine the host edge node whose load parameters satisfy the selected conditions.

The host conditions may include that the target base station may include a base station with a bandwidth greater than or equal to a bandwidth threshold and the smallest distance from the offline edge node in the edge node network. The load parameter satisfying the selected conditions may include that the host edge node may include the edge node with the smallest load in the target base station.

In some embodiments, the state acquisition unit 804 may be further configured to determine a candidate edge node for the offline edge node in the edge node network when the current node state of the offline edge node indicates that the offline edge node is in the service unavailable state or the failure state, and re-establish the service corresponding to the offline edge node at the candidate edge node.

For the specific implementation of each unit in embodiments of the present disclosure, reference may be made to the corresponding content above, which is not described in detail here.

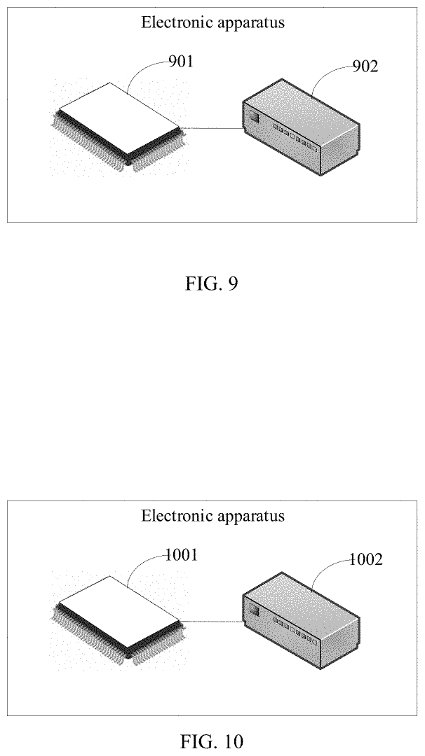

FIG. 9 illustrates a schematic structural diagram of an electronic apparatus according to some other embodiments of the present disclosure. The electronic apparatus includes a memory 901 and a processor 902. The memory 901 may be used to store an application program and data generated by the running of the application program. The processor 902 may be configured to execute the application program to, when receiving the host information sent by the management node in the edge node network, determine the current edge node as the host edge node. The host information may at least include the node information of the hosted offline edge. The processor 902 may be further configured to establish the communication connection with the offline edge node according to the node information in the host information, obtain the current node state of the offline edge node through the communication connection, and transmit the current node state of the offline edge node to the management node.

According to the above solution, the electronic apparatus of embodiments of the present disclosure may detect whether the offline edge node exists in the edge node network at the management node of the edge node network. When at least one offline edge node is detected, the management node may determine the host edge node for the offline edge node and send the host information to the host edge node. Thus, the host edge node may obtain the current node state of the offline node after establishing the communication connection with the offline edge node according to the node information of the offline edge node that is hosted included in the host information. As such, the management node may obtain the current node state of the offline edge node transmitted by the management node. Thus, in embodiments of the present disclosure, even if the offline edge node, that is the disconnected node, exists, the management node may obtain the node state of the offline edge node. Therefore, the management node may determine whether the node can provide service normally.

FIG. 10 illustrates a schematic structural diagram of an electronic apparatus according to some other embodiments of the present disclosure. The electronic apparatus includes a memory 1001 and a processor 1002. The memory 1001 may be used to store an application program and data generated by running the application program. The processor 1002 may be configured to, when detecting at least one offline edge node, determine the host edge node for the offline edge node execute the application program to detect whether the offline edge node exists in the edge node network. The processor 1002 may be further configured to send the host information to the host edge node. Thus, the host edge node may establish the communication connection with the offline edge node according to the node information of the hosted offline edge node included in the host information. The processor 1002 may be further configured to obtain the current node state of the offline edge node through the communication connection and obtain the current node state of the offline edge node transmitted by the host edge node.

According to the above solution, the electronic apparatus of embodiments of the present disclosure may detect whether the offline edge node exists in the edge node network at the management node of the edge node network. When at least one offline edge node is detected, the management node may determine the host edge node for the offline edge node and send the host information to the host edge node. Thus, the host edge node may obtain the current node state of the offline node after establishing the communication connection with the offline edge node according to the node information of the offline edge node that is hosted included in the host information. As such, the management node may obtain the current node state of the offline edge node transmitted by the management node. Thus, in embodiments of the present disclosure, even if the offline edge node, that is the disconnected node, exists, the management node may obtain the node state of the offline edge node. Therefore, the management node may determine whether the node can provide service normally.

The technical solution of the present disclosure is described in detail below.

First, during the process of maintaining the edge nodes, the inventors of the present disclosure discovered that many edge nodes are deployed in unattended remote areas, and the network connection with the cloud management node is very unstable. When the edge node loses connection with the cloud management node, the edge node is in an offline state, and the management node cannot know an operation state of the edge node and manage the edge node.

In the existing KubeEdge edge autonomous solution, when the cloud management node finds that the web socket connection with the edge node is disconnected, the node may enter the edge autonomous state by default. When the edge node detects that the connection with the cloud is disconnected, the edge node may automatically start the local container management agent Edged when the edge node is working normally and restart the local service using the cached metadata.

However, the inventors of the present disclosure found that, in this solution, the situation of the failure of the edge node is not considered. When the edge node has a hardware or software failure, the edge autonomous operation cannot be started normally. The node can no longer report the node state to the management node when the node is disconnected. Thus, the management node cannot determine whether the node is in the edge autonomous state or the failure state after discovering that the node is disconnected. Once the edge node fails, the management node cannot detect and handle the failure in time, which may cause the business to fail to provide services to customers for a long time.

In view of the above problems and the deficiencies of the existing solution, the inventors of the present disclosure provide the following solutions.

First, a scheduling module may be added to the cloud management node and configured to collect and analyze information of the network topology between the edge nodes, the geographical location relationship, and the load of the neighboring base station. The scheduling module may be configured to search for an optimal host edge node that can capture the state of the offline edge node for the offline node.

Second, a soft SIM card module (i.e., the above SIM card control module) and a baseband/radiofrequency (RF) module may be added to the edge node. The offline edge node and the host edge node may start the SIM card module by downloading over-the-air technology (OTA) through the air when discovering that the node is disconnected. The soft SIM card module and the baseband/RF module may be further configured to build a temporary wireless channel to establish a secure communication connection between a selected managed edge node and the offline edge node.

Thus, the host edge node may capture the state of the offline node using the dynamically established secure communication connection and determine whether the offline node can still provide the services normally based on the captured information. If the information is not captured over time, the host edge node may determine that the node may have a failure.

After using the technical solution of the present disclosure, the cloud management node may search for an optimal host edge node for the edge node after the edge node is offline, capture the state of the offline edge node, and detect the node failure in time. Moreover, the host edge node may also report the state of the offline edge node through the temporarily established wireless secure communication connection without establishing a redundant backup network in advance, which greatly saves deployment cost.

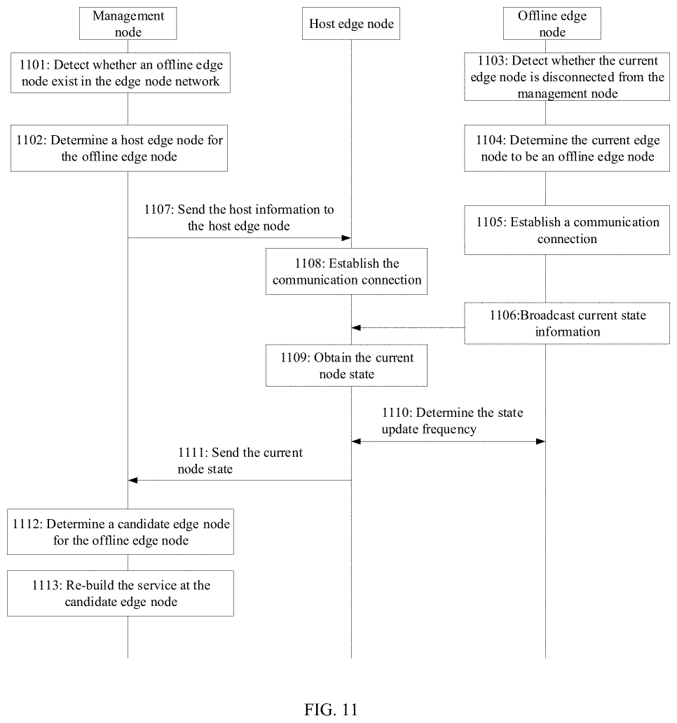

FIG. 11 illustrates a schematic diagram showing an interaction among a management node, a host edge node, and an offline edge node according to some embodiments of the present disclosure. The technical solution of the present disclosure is described as follows.

At 1101, the management node detects whether an offline edge node exists in the edge node network.

At 1102, when the management node detects at least one offline edge node, the management node determines a host edge node for the offline edge node.

In some embodiments, step 1102 includes obtaining the network connection parameters between the offline edge node and other edge nodes in the edge node network and, in other edge nodes in the edge node network, determining the host edge node whose network connection parameters satisfy the host condition.

The host conditions may include the network transmission delay parameter between the host edge node and the offline edge node being the smallest among network transmission delay parameters between all the edge nodes in the edge node network and the offline edge node, and/or, the number of network routing forwarding hops between the host edge node and the offline edge node being the smallest among numbers of the network routing forwarding hops between all the edge nodes in the edge node network and the offline edge node.

In some embodiments, step 1102 includes obtaining the network connection parameters between the offline edge node and other base stations in the edge node network. The other base stations in the edge node network may be different from the base station to which the offline edge node belongs. Step 1102 further includes, in other base stations in the edge node network, determining a target base station with the network connection parameters satisfying the host conditions and determining the host edge node whose load parameters satisfy the selected condition in the target base station.

The host conditions may include that the target base station may include a base station with a bandwidth greater than or equal to a bandwidth threshold and the smallest distance from the offline edge node in the edge node network. The load parameter satisfying the selected conditions may include that the host edge node may include the edge node with the smallest load in the target base station.

At 1103, whether the current edge node is disconnected from the management node is detected.

At 1104, when detecting that the current edge node is disconnected from the management node, the current edge node is determined to be an offline edge node.

At 1105, the offline edge node applies for a second communication identifier from the communication base station and downloads a communication profile to establish a communication connection capable of sending current state information.

At 1106, the offline edge node broadcasts current state information through the established communication connection.

At 1107, the management node sends the host information to the host edge node.

At 1108, the host edge node establishes the communication connection with the offline edge node according to the node information in the host information.

The host edge node may use the first communication identifier in the host edge node to establish the communication connection with the offline edge node.

At 1109, the host edge node obtains the current node state through the communication connection.

The host edge node may obtain the current node state of the offline edge node according to the current state information when receiving the current state information sent by the offline edge node through the communication connection. The current node state may indicate that the offline edge node is in the failure state.

When the host edge node cannot receive the current state information sent by the offline edge node through the communication connection, the host node may obtain the current node state of the offline edge node. The current node state may indicate that the offline edge node is in the autonomous state or the service unavailable state.

At 1110, when the host edge node receives the current state information sent by the offline edge node through the communication connection, the host edge node determines the state update frequency according to the communication connection and the offline edge node.

Thus, the offline edge node may update the current state information of the offline edge state according to the state update frequency and send the current state information to the host edge node until the current state information indicates that the offline edge node and the management node are in the connected state.

At 1111, the host edge node sends the current node state of the offline edge node to the management node. Thus, the management node obtains the current node state of the offline edge node transmitted by the host edge node.

At 1112, when the current node state of the offline edge node indicates that the offline edge node is in the service unavailable state or the failure state, the management node determines a candidate edge node for the offline edge node in the edge node network.

At 1113, the management node rebuilds the service corresponding to the offline edge node at the candidate edge node.

In addition, the management node may update the database state according to the current node state of the offline edge node. The management node may send a notification message to the host edge node when the current node state indicates the recovery of the connected state between the offline edge node and the management node. Thus, the host edge node may close the communication connection with the offline edge node and switch the first communication identifier to an inactive state.

When the offline edge node detects the recovery of the connection with the management node, the host edge node may close the communication connection with the offline edge node, delete the communication profile, and send a logout message to the communication base station to notify the communication base station to log out the second communication identifier.

In some embodiments, the solution is described as follows.

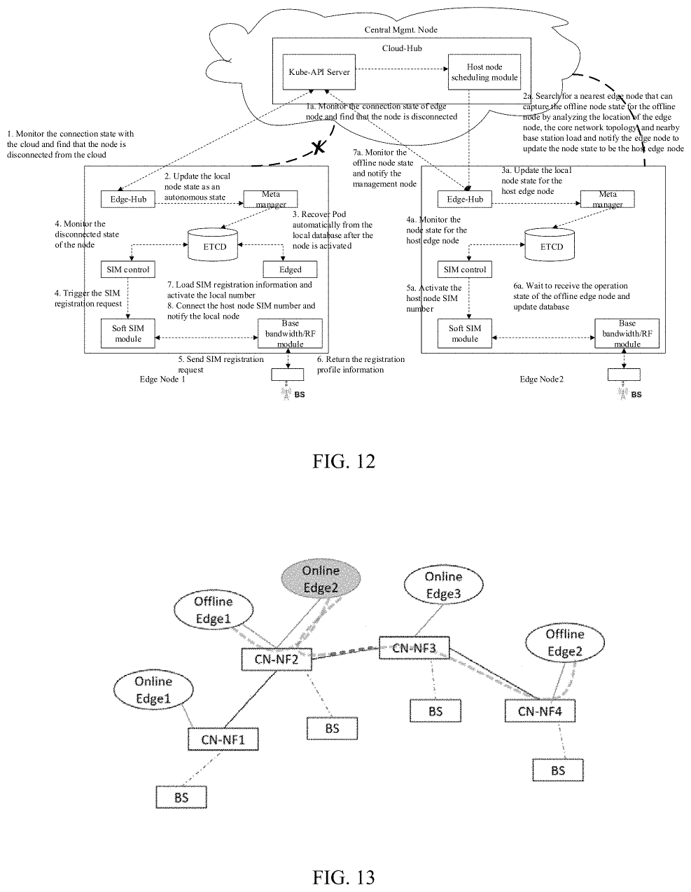

FIG. 12 shows a workflow of updating the node state after the offline edge node is disconnected from the cloud management node. For example, in FIG. 12, EdgeNode1 is an offline edge node, EdgeNode2 is a host edge node, and Central mgmt.Node is a cloud management node. Each node will have a built-in configuration file (i.e., the communication profile above) for hosting the SIM card number. The SIM card number may be activated when the node is selected as the host edge node by the management node.

After the node is disconnected, a specific processing process on the side of the offline edge node includes the following processes.

1. Offline edge node module EdgeHub monitors the websocket connection with the cloud management node Cloud-Hub and finds that the offline edge node is disconnected from the cloud management node.

2. Meta manager is notified that the database will be updated, and the local node is set to a disconnected state.

3. After the offline edge node restarts, the local container management agent EdgeD will restart the Pod. If the Pod runs normally, the node will be set to a disconnected autonomous state. If the Pod cannot run normally, the node will be set to a disconnected service unavailable state.

4. The SIM card control module of the offline edge node monitors the state of the local node. If the node is in a disconnected state, a registration request is sent to the soft SIM card.

5. The soft SIM card of the offline edge node requests the SIM card configuration file from the base station (BS) through the OTA protocol, downloads the installation configuration file, loads the SIM registration information, and activates the offline node SIM card number.

6. The SIM card control module of the offline node sends a node state release instruction to notify the soft SIM card to send a message to the host SIM number to update the node state to be disconnected autonomous or disconnected service unavailable and negotiate the state update frequency.

7. The soft SIM card module of the offline edge node receives a confirmation notification and a negotiation result from the host SIM number and sends a state update message to the host SIM number according to an agreed frequency.

8. When the offline edge node monitors the recovery of the connection with the cloud, the offline edge node notifies the host SIM that the node state is connected and closes the update channel. Meanwhile, the offline edge node deletes the SIM card configuration file and notifies the base station to cancel the SIM card number registration.

The specific processing process on the side of the cloud management node and host node includes the following processes.

1a. The cloud management node cloudhub module monitors the websocket connection with the offline node Edgehub, finds that the node is disconnected, and notifies the host node scheduling module.

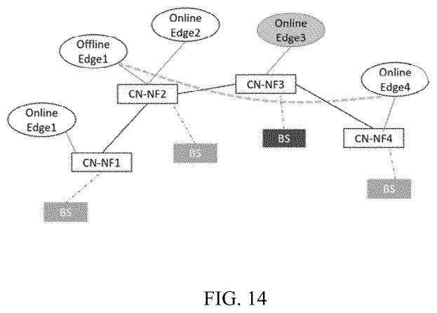

2a. The host node scheduling module searches for a nearest edge node that can capture the offline node state for the offline node by analyzing the location of the edge node, the core network topology, and nearby base station load. The host node scheduling module also notifies the metamanager of the edge node to update the node state to be the host edge node. For the specific search process, reference may be made to the description of FIG. 13 and FIG. 14.

3a, 4a, and 5a, The SIM card control module of the host edge node monitors the node state change. When the node has become a host edge node, the SIM card control module activates the host SIM configuration file and waits to receive the state update message sent by the offline edge node.

6a. After the host edge node captures the state update message sent by the offline edge node, the host edge node notifies the cloud management node to update the node state to be the disconnected autonomous or disconnected service unavailable state. If the message sent by the offline edge node is not captured over time, the cloud management node is notified that the offline edge node state is in the system failure state.

7a. The host edge node monitors the state of the offline edge node and notifies the central node that is the management node. If the node is in the disconnected service unavailable state or the system failure state, the management node will rebuild the service run at the offline node at another node as soon as possible to ensure that the services may be still provided to the outside. Meanwhile, the management node notifies the operation and maintenance technician to repair the failure. If the node is in the disconnected autonomous state, the management node only updates the database state and waits for the offline node to automatically restore the connection.

FIGS. 13 and 14 show specific processes of the host node scheduling module searching for the best host edge node for the offline edge node. When the cloud management node collects wireless the core network topology, performance index data, and neighboring base station parameter data at the same time, the solution includes the solution in FIG. 13.

FIG. 13 shows a search process when the cloud management node supports the analysis of the wireless core network topology and performance identifiers. In FIG. 13, base station CN-NF1 includes an online edge node Edge1. Base station CN-NF2 includes online edge node Edge1 and online edge node Edge2. Base station CN-NF3 includes online edge node Edge3. Base station CN-NF4 includes offline edge node Edge2. The search process includes the following processes.

1. The host node scheduling module collects the topological connection between all the edge nodes and wireless core network node and performance parameters, including edge node location information, connected core network node information, network performance parameters between the edge nodes and the core network nodes (including, delay, throughput, etc.), and link performance parameters between the core network nodes (including, link delay, throughput, etc.).

2. According to the collected performance identification and topology, the end-to-end delay and the number of the routing and forwarding hops from the offline edge node to other online edge nodes are calculated via the wireless core network node.

3. The edge node with the least delay or the least number of hops to the offline edge node is selected as the host node.

4. When more offline edge nodes are included, the edge node with the smallest average delay or the smallest average number of routing hops from the plurality of edge nodes is selected as the host node.

For example, for offline edge node Edge1 at base station CN-NF2 and offline edge node Edge2 at base station CN-NF4, online edge node Edge2 at base station CN-NF2 is selected as the host edge node.

FIG. 14 shows a search process when the cloud management node can only analyze the base station parameters. In FIG. 14, moderately loaded base station CN-NF1 includes online edge node Edge1. Moderately loaded base station CN-NF2 includes offline edge node Edge1 and online edge node Edge2. Heavily loaded base station CN-NF3 includes online edge node Edge3. Lightly loaded base station CN-NF4 includes offline edge node Edge4. The search process includes the following processes.

1. The host node scheduling module collects the parameter information of all the edge nodes and nearby base stations, including the location information, the base stations to which the edge nodes belong, and loads of the edge nodes, and the location information and the load (such as bandwidth usage, etc.) of the base stations.

2. The distance between the offline edge node and the base station to which other online edge nodes belong is calculated based on the collected location information of the edge nodes and the base station.

3. A base station that meets the requirements of the available bandwidth threshold and is closest to the base station to which the offline edge node belongs is selected.

4. An edge node with a least load is selected from the coverage of the selected base station as the host node.

5. When more offline edge nodes are included, a base station that meets the requirements of the available bandwidth threshold and has the smallest average distance to the base station to which the more offline edge nodes belong is selected. An edge node with the least load from the coverage area of the base station is selected as the host node.

For example, light-load base station CN-NF4 may be selected for offline edge node Edge1 at base station CN-NF2. Online edge node Edge4 may be selected as the host edge node at the base station CN-NF4.

The various embodiments in this specification are described in a progressive manner, and each embodiment focuses on the differences from other embodiments. The same or similar parts between the various embodiments may be referred to each other. For the device disclosed in embodiments of the present disclosure, since the device corresponds to the method disclosed in embodiments of the present disclosure, the description is relatively simple. For the relevant part, reference may be made to the description of the method part.

Those of skill in the art may further realize that the units and algorithm steps of the examples described in embodiments of the present disclosure may be implemented by electronic hardware, computer software, or a combination thereof to clearly illustrate the interchangeability of hardware and software. In the above description, the composition and steps of the examples have been generally described in accordance with the function. Whether these functions are executed by hardware or software depends on the specific application and design constraint conditions of the technical solution. Those of skill in the art may use different methods for each specific application to implement the described function, but such implementation should not be considered beyond the scope of the present disclosure.

The steps of the method or algorithm described in embodiments of the present disclosure may be directly implemented by hardware, a software module executed by a processor, or a combination thereof. The software module may be arranged in random access memory (RAM), internal memory, read-only memory (ROM), electrically programmable ROM, electrically erasable programmable ROM, registers, hard disks, portable disks, CD-ROMs, or a storage medium of any other form well known in the technical field.

The above description of the above embodiments enables those skilled in the art to implement or use the present disclosure. Various modifications made to embodiments of the present disclosure will be obvious to those skilled in the art. The general principles defined herein may be implemented in other embodiments without departing from the spirit or scope of the present disclosure. Therefore, the present disclosure will not be limited to the embodiments shown in this specification but should conform to the widest scope consistent with the principles and novel features disclosed in the specification.

What is claimed is:

1. A control method comprising:
in response to receiving host information sent by a management node in an edge node network, determining a current edge node as a host edge node, and the host information including at least node information of a hosted offline edge node;
establishing a communication connection with the offline edge node according to the node information in the host information;
obtaining a current node state of the offline edge node through the communication connection; and
transmitting the current node state of the offline edge node to the management node.

2. The method according to claim 1, wherein establishing the communication connection with the offline edge node according to the node information in the host information includes:
establishing the communication connection with the offline edge node according to a first communication identifier in the host edge node.

3. The method according to claim 1, wherein obtaining the current node state of the offline edge node through the communication connection includes:
in response to receiving current state information sent by the offline edge node to the host edge node through the communication connection, obtaining the current node state of the offline edge node according to the current state information, the current node state indicating that the offline edge node is in an autonomous state or a service unavailable state; and
in response to not receiving the current state information sent by the offline edge node to the host edge node through the communication connection, obtaining the current node state of the offline edge node, the current node state indicating that the offline edge node is in a failure state.

4. The method according to claim 3, further comprising, in response to receiving the current state information sent by the offline edge node to the host edge node through the communication connection:
determining a state update frequency through the communication connection and the offline edge node, so that the offline edge node updates the current state information of an offline edge state according to the state update frequency and sends the current state information to the host edge node until the current state information indicates that the offline edge node and the management node are in a connected state.

5. The method according to claim 4, wherein in response to the offline edge node and the management node being in the connected state, closing the communication connection between the offline edge node and the host edge node.

6. A control method comprising:
detecting whether an offline edge node exists in an edge node network;
in response to detecting at least one offline edge node, determining a host edge node for the offline edge node;
sending host information to the host edge node, so that the host edge node establishes a communication connection with the offline edge node according to node information of the hosted offline edge node included in the host information and obtains a current node state of the offline edge node through the communication connection; and
obtaining the current node state of the offline edge node transmitted by the host edge node.

7. The method according to claim 6, wherein determining the host edge node for the offline edge node includes:
obtaining network connection parameters between the offline edge node and other edge nodes in the edge node network; and
in other edge nodes of the edge node network, determining the host edge node with the network connection parameters satisfying host conditions, the host conditions including:
a network transmission delay parameter between the host edge node and the offline edge node being smallest in network transmission delay parameters between all edge nodes in the edge node network and the offline edge node; and/or
a number of network routing and forwarding hops between the host edge node and the offline edge node being smallest in numbers of network routing and forwarding hops between all the edge nodes in the edge node network and the offline edge node.

8. The method according to claim 6, wherein determining the host edge node for the offline edge node includes:
obtaining network connection parameters between the offline edge node and other base stations in the edge node network, the other base stations including base stations in the edge node network that are different from a base station to which the offline edge node belongs;
in the other base stations in the edge node network, determining a target base station whose network connection parameters satisfying a host condition, the host condition including the target base station including a base station whose available bandwidth in the edge node network is greater than or equal to a bandwidth threshold and with a smallest distance from the offline edge node; and
in the target base station, determining the host edge node whose load parameters satisfying a selected condition, the load parameters satisfying the selected condition including the host edge node being an edge node with a least load in the target base station.

9. The method of claim 6, further comprising:
in response to the current node state of the offline edge node indicating that the offline edge node is in a service unavailable state or a failure state, determining a candidate edge node for the offline edge node in the edge node network; and
rebuilding services corresponding to the offline edge node at the candidate edge node.

10. The method of claim 6, further comprising:
in response to the current node state of the offline edge node indicating that the offline edge node is in an autonomous state, updating the state of the offline edge node in database and waiting for recovery of connection between the offline edge node and a management node.

11. A control device comprising:
an information reception unit configured to receive host information sent by a management node in an edge node network;
a host determination unit configured to, in response to receiving the host information sent by the management node in the edge node network, determining a current edge node as a host edge node, and the host information including at least node information of a hosted offline edge node;
a connection establishment unit configured to establish a communication connection with the offline edge node according to the node information in the host information;
a state acquisition unit configured to obtain a current node state of the offline edge node through the communication connection; and
a transmission unit configured to transmit the current node state of the offline edge node to the management node.

12. The device according to claim 11, wherein the connection establishment unit is further configured to:
establish the communication connection with the offline edge node according to a first communication identifier in the host edge node.

13. The device according to claim 11, wherein the state acquisition unit is further configured to:
in response to receiving current state information sent by the offline edge node to the host edge node through the communication connection, obtain the current node state of the offline edge node according to the current state information, the current node state indicating that the offline edge node is in an autonomous state or a service unavailable state; and
in response to not receiving the current state information sent by the offline edge node to the host edge node through the communication connection, obtain the current node state of the offline edge node, the current node state indicating that the offline edge node is in a failure state.

14. The device according to claim 13, wherein the state acquisition unit is further configured to, in response to being able to receive the current state information sent by the offline edge node to the host edge node through the communication connection:
determine a state update frequency through the communication connection and the offline edge node, so that the offline edge node updates the current state information of an offline edge state according to the state update frequency and sends the current state information to the host edge node until the current state information indicates that the offline edge node and the management node are in a connected state.

15. The device according to claim 14, wherein in response to the state acquisition unit determining the connected state between the offline edge node and the management node, the host edge node closes the communication connection between the offline edge node and the host edge node.

16. The device according to claim 11, further comprising:
an offline detection unit configured to detect whether an offline edge node exists in an edge node network;
a determination unit configured to, in response to the offline detection unit detecting at least one offline edge node, determine a host edge node for the offline edge node; and
an information transmission unit configured to send host information to the host edge node, the host edge node establishing a communication connection with the offline edge node according to node information of the hosted offline edge node included in the host information and obtaining a current node state of the offline edge node through the communication connection.

17. The device according to claim 16, wherein the determination unit is further configured to:
obtain network connection parameters between the offline edge node and other edge nodes in the edge node network; and
in other edge nodes of the edge node network, determine the host edge node with the network connection parameters satisfying host conditions, the host conditions including:
a network transmission delay parameter between the host edge node and the offline edge node being smallest in network transmission delay parameters between all edge nodes in the edge node network and the offline edge node; and/or
a number of network routing and forwarding hops between the host edge node and the offline edge node being smallest in numbers of network routing and forwarding hops between all the edge nodes in the edge node network and the offline edge node.

18. The device according to claim 16, wherein the determination unit is further configured to:
obtain network connection parameters between the offline edge node and other base stations in the edge node network, the other base stations including base stations in the edge node network that are different from a base station to which the offline edge node belongs;
in the other base stations in the edge node network, determine a target base station whose network connection parameters satisfying a host condition, the host condition including the target base station including a base station whose available bandwidth in the edge node network is greater than or equal to a bandwidth threshold and with a smallest distance from the offline edge node; and
in the target base station, determining the host edge node whose load parameters satisfying a selected condition, the load parameters satisfying the selected condition including the host edge node being an edge node with a least load in the target base station.

19. The device of claim 16, wherein the state acquisition unit is further configured to:
in response to the current node state of the offline edge node indicating that the offline edge node is in a service unavailable state or a failure state, determine a candidate edge node for the offline edge node in the edge node network; and
rebuild services corresponding to the offline edge node at the candidate edge node.

20. The device of claim 16, wherein the state acquisition unit is further configured to:
in response to the current node state of the offline edge node indicating that the offline edge node is in an autonomous state, update the state of the offline edge node in database and wait for recovery of connection between the offline edge node and a management node.
